(19) United States
(12) Patent Application Publication
(10) Pub. No.: US 2023/0169125 A1
(43) Pub. Date: Jun. 1, 2023

(54) INFORMATION PROCESSING SYSTEM, INFORMATION PROCESSING METHOD, INFORMATION PROCESSING DEVICE, AND COMPUTER PROGRAM PRODUCT

(71) Applicant: KABUSHIKI KAISHA TOSHIBA, Tokyo (JP)

(72) Inventor: Yasuki TANABE, Yokohama Kanagawa (JP)

(73) Assignee: KABUSHIKI KAISHA TOSHIBA, Tokyo (JP)

(21) Appl. No.: 17/820,221

(22) Filed: Aug. 16, 2022

(30) Foreign Application Priority Data
Nov. 30, 2021 (JP) 2021-193887

(51) Int. Cl. G06F 16/906; G06K 9/62

(52) U.S. Cl. CPC G06F 16/906; G06K 9/6267

(57) ABSTRACT

An information processing system according to one embodiment includes information processing devices. Each device includes one or more hardware processors functioning to accept input of processing data and detect whether a classification of the processing data is a target classification or a non-target classification. The target classification is a target of first processing. The non-target classification is not a target of the first processing. The hardware processors function to execute the first processing on the processing data upon detection of the classification of the processing data being the target classification. The hardware processors function to determine, as a destination device, an information processing device serving to perform processing on data of the non-target classification. The determination is made upon detection of the classification of the processing data being the non-target classification. The hardware processors function to transmit the processing data to the destination device.

### CROSS-REFERENCE TO RELATED APPLICATIONS

This application is based upon and claims the benefit of priority from Japanese Patent Application No. 2021-193887, filed on Nov. 30, 2021; the entire contents of which are incorporated herein by reference.

### FIELD

Embodiments described herein relate generally to an information processing system, an information processing method, an information processing device, and a computer program product.

### BACKGROUND

There is a known system in which multiple Internet of Things (IoT) devices (edge devices) perform distributed processing for various types of data. For example, there is a technique of determining processing to be executed by a robot, which is one type of IoT device, and processing to be executed by a surveillance server, on the basis of acquired image data and at least one of tracking operation environment information, communication quality, and load information. Such a configuration enables the execution of distributed processing even between devices having different throughput.

Another technique has been proposed, in which pieces of processing are implemented on lightweight virtual machines and those virtual machines are installed on IoT devices in a distributed manner, thereby achieving improvement of overall scalability of processing and the like.

### BRIEF DESCRIPTION OF THE DRAWINGS

FIG. 1 is a block diagram of an information processing system according to an embodiment;

FIG. 2 is a block diagram of an IoT device;

FIG. 3 is a block diagram of a server;

FIG. 4 is a diagram illustrating an example data structure of association information;

FIG. 5 is a flowchart of information processing according to a first embodiment;

FIG. 6 is a flowchart of information processing at a destination device;

FIG. 7 is a diagram illustrating an example configuration of the information processing system;

FIG. 8 is a diagram illustrating example distributed processing using two IoT devices;

FIG. 9 is a diagram illustrating example distributed processing using three IoT devices;

FIG. 10 is a block diagram of an IoT device according to a second embodiment;

FIG. 11 is a flowchart of information processing according to the second embodiment; and

FIG. 12 is a diagram of hardware configuration of the device according to the first or second embodiment.

### DETAILED DESCRIPTION

An information processing system according to an embodiment includes a plurality of information processing devices, each device including one or more hardware processors. The processors accept input of processing data. The processors detect whether a classification of the processing data is a target classification or a non-target classification. The target classification is a target of predetermined first processing. The non-target classification is not a target of the first processing. The processors execute the first processing on the processing data upon detection of the classification of the processing data being the target classification. The processors determine, as a destination device, a device in the plurality of information processing devices that serves to perform processing on data of the non-target classification. The determination is made upon detection of the classification of the processing data being the non-target classification. The processors transmit at least some pieces of the processing data to the determined destination device.

Preferred embodiments of information processing devices of the present disclosure will be described in detail below with reference to the attached drawings.

As described above, the following systems S1 and S2 are available as systems achieving distributed processing by multiple devices.

S1: System distributing processing between an IoT device (a robot) and a server (such as a surveillance server)

S2: System using a virtual machine

In the system S1, there is a case where the server carries out the processing. Thus, a higher-performance server having high throughput should be prepared. Preparing a high-performance device may increase cost. Moreover, data needs to be transmitted to the server, and thereby network traffic increases. A server is not typically configured to specialize in a specific application, so that power consumption in executing each piece of processing on the server tends to increase in comparison with power consumption in executing processing on a dedicated device for a specific application. Therefore, the system S1 distributing the processing to the server may consume more power as the entire system.

If there is data that is undesirable to be transmitted to a public network (for example, data having a low level of abstraction, such as image data itself acquired by a camera), a configuration using a server as in the system S1 may not be employed because of privacy and security requirements.

Moreover, in the configuration of the system S1, if, for example, an IoT device does not have capability of having a new function that needs to be installed, the server is required to have this function in order to take the place of the IoT device. In this case, a load on the server further increases.

Another measure in consideration of the need to implement a new function is to preliminarily design a device that can achieve an advanced function on the assumption that a function is added. An example method may be to provide extra computing capability to an arithmetic device such as a central processing unit (CPU) and a graphics processing unit (GPU). Unfortunately, this method requires preparation of a higher-performance device and may cause a problem of an increase in the device size to allow expandability in the device performance.

In the system S2, each piece of hardware needs to have computing capability to execute the virtual machine. Each hardware also needs to be designed to have an operating system (OS) environment in which the virtual machine can be executed, a virtual machine execution environment, or the like.

However, for example, an IoT device highly specializing in specific application, especially an IoT device implemented to be lightweight may not have capability to execute a virtual machine and may not be applied to a system like S2. If an IoT device is implemented to execute a virtual machine, the configuration may be complex for improvement in computing performance, support for OS execution, and the like.

Moreover, the configuration using a virtual machine like S2 may not effectively utilize the capability of an IoT device specializing in a specific application and implemented to be lightweight. For example, even if an IoT device having hardware specific to artificial intelligence (AI) processing, such as person authentication, is implemented (brought to market or the like), a device is configured to execute a virtual machine without employing the IoT device. A device that specializes in a specific application and may reduce power consumption is not used, which fails to achieve efficiency in power consumption.

In the system S2, processing is distributed in virtual machine units. Thus, to cause another device to execute the processing, each piece of data including data to be processed (hereinafter referred to as processing data) and a virtual machine image needs to be transmitted, resulting in a heavy communication load. The virtual machine image may be preliminarily stored in the device; however, this requires a storage device (data storage) storing the virtual machine image, resulting in a complex configuration of the IoT device.

Considering the above, in an information processing system according to an embodiment, if processing (non-target processing) other than predetermined specific processing (first processing) being a target for an IoT device is necessary, another IoT device specializing in the non-target processing is determined. Then, data is transmitted (transferred) to the determined device (destination device), and this device performs the non-target processing as a substitute. For example, each IoT device is configured as a dedicated device that specializes in execution of specific processing assigned to the device. The non-target processing is processing other than the specific processing, such as processing that cannot be handled by the IoT device and processing that cannot be efficiently executed by the IoT device. At least some of IoT devices 100 are assigned mutually different pieces of processing as the specific processing.

### First Embodiment

In an information processing system according to a first embodiment, a server selects an IoT device specializing in specific processing that is non-target processing for another IoT device.

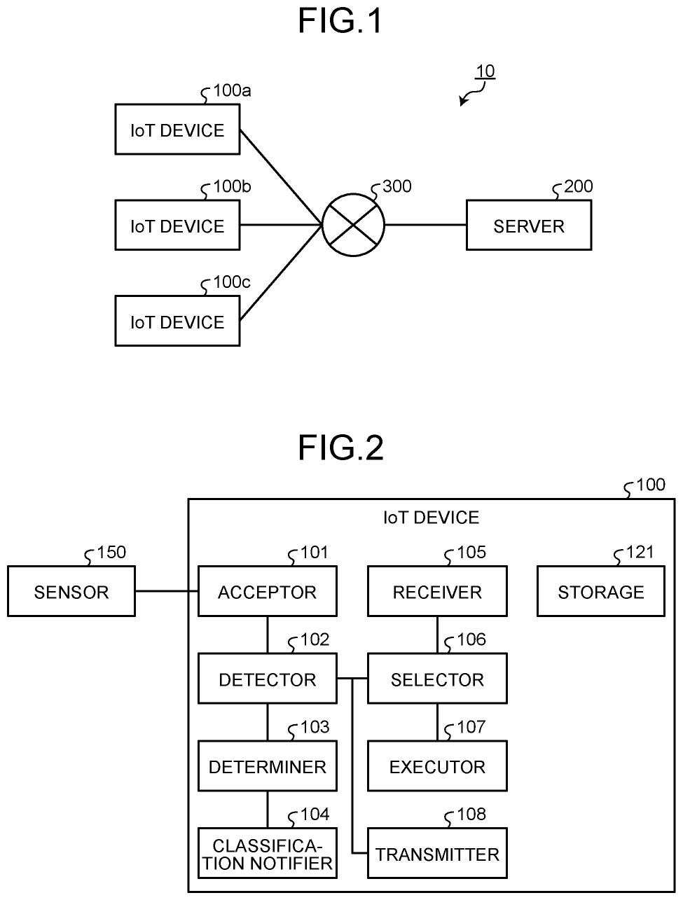

FIG. 1 is a block diagram illustrating an example configuration of an information processing system 10 according to this embodiment. As illustrated in FIG. 1, the information processing system 10 includes IoT devices 100a, 100b, and 100c (example information processing devices) and a server 200 that are connected via a network 300.

The IoT devices 100a, 100b, and 100c have similar configurations and, when not needed to be distinguished from each other, are thus simply referred to as IoT devices 100. The number of the IoT devices 100 is not limited to three and may be two or four or more.

The server 200 may be configured as a single physical device or may be constructed in a cloud environment.

The network 300 is, for example, a local area network (LAN) or the Internet. The network 300 may be either a wired network or a wireless network.

FIG. 2 is a block diagram illustrating an example configuration of the IoT device 100. As illustrated in FIG. 2, the IoT device 100 includes an acceptor 101, a detector 102, a determiner 103, a classification notifier 104, a receiver 105, a selector 106, an executor 107, a transmitter 108, and a storage 121.

The IoT device 100 is connected to a sensor 150. The IoT device 100 and the sensor 150 may be connected to each other in any configuration, for example, with a dedicated line via the network 300. The sensor 150 corresponds to a device (input device) acquiring processing data to be processed by the IoT device 100. The IoT device 100 may be connected to two or more types of the sensors 150.

The sensor 150 may be of any type and is, for example, a camera (capturing device), a temperature sensor, a humidity sensor, a vibration sensor, an acoustic sensor, or the like. The sensor 150 may be provided inside the IoT device 100. An example using a camera capturing image data (such as a video stream and a still image) as the sensor 150 will be mainly described below.

The acceptor 101 accepts input of processing data from the sensor 150. For example, if the sensor 150 is a camera, the acceptor 101 accepts image data captured by the camera as the processing data.

The detector 102 detects a classification of the processing data. For example, the detector 102 detects whether the classification of the accepted processing data is a classification being a target of specific processing assigned to its own IoT device 100 (hereinafter referred to as a target classification) or a classification not being a target of the specific processing (hereinafter referred to as a non-target classification).

If the classification of the processing data is the target classification, the detector 102 inputs the processing data to the selector 106. If the classification of the processing data is the non-target classification, the detector 102 inputs the detection result to the determiner 103 and inputs the processing data or a portion of the processing data to the transmitter 108 as a preparation for the transmission to another IoT device 100.

The detector 102 may execute recognition processing recognizing a data classification (class) on the processing data to detect the classification of the processing data on the basis of a result of the recognition processing. For example, the detector 102 executes object recognition processing recognizing (detecting) a vehicle, a person, a transfer robot, and an object whose classification is unknown, on the image data captured by the camera.

An example case in which the specific processing is vehicle identification processing will be described. The vehicle identification processing, for example, recognizes a license number through image recognition on image data and determines whether the vehicle is a vehicle permitted to pass (permitted vehicle). If the recognition processing recognizes a vehicle, the detector 102 determines that the classification of the processing data is the target classification. If the recognition processing recognizes an object (a person, a transfer robot, or an objects whose classification is unknown) other than a vehicle, the detector 102 determines that the classification of the processing data is the non-target classification.

In a case where a vehicle is recognized, the detector 102 transmits the processing data (image data) or a portion of the data (partial data) to the selector 106. The partial data corresponds to, for example, a portion used for processing at the executor 107, of the processing data. For example, data in a region containing the recognized object (such as the vehicle) in the image data may correspond to the partial data.

In a case where an object other than a vehicle is recognized, the detector 102, for example, transmits classification information indicating the recognized classification to the determiner 103 and inputs the processing data (image data) or the partial data to the transmitter 108. After the determiner 103 determines another IoT device 100 as a destination, the processing data or the partial data is transmitted to the determined IoT device 100.

When the classification of the processing data is detected to be the non-target classification, the determiner 103 determines another IoT device 100, which serves to perform processing on the data of the non-target classification, as a destination device to which the processing data is to be transmitted. For example, the determiner 103 queries the server 200 for an IoT device 100 associated with the non-target classification by using the classification notifier 104, thereby determining the destination device.

When the classification of the processing data is detected to be the non-target classification, the classification notifier 104 notifies the server 200 of notification information including the detected non-target classification. The notification information from the classification notifier 104 may further include identification information identifying its own IoT device 100.

As described later, the server 200 selects an IoT device 100 for processing the processing data of the non-target classification included in the notification information and returns device information indicating the selected device. The device information is received by, for example, the classification notifier 104 or the receiver 105 and passed to the determiner 103. The determiner 103 determines the IoT device 100 indicated by the received device information as the destination device.

The receiver 105 receives data from external devices, such as another IoT device 100 and the server 200. For example, the receiver 105 receives the processing data (transfer data) transmitted from another IoT device 100 and the identification information of the source IoT device 100. The receiver 105 transmits the received processing data and identification information to the selector 106.

The selector 106 selects data to be processed by the executor 107. For example, the selector 106 selects data to be processed by the executor 107 from the processing data (or partial data) input from the detector 102 and the transfer data input from the receiver 105. The selection may be made in accordance with any criterion, and, for example, a selection method using the priority of data or the like may be applied. The priority may indicate that, for example, data input from the detector 102 has priority over data received by the receiver 105, or vice versa.

The executor 107 executes the specific processing assigned to its own IoT device 100. For example, when the detector 102 detects that the classification of the processing data is the target classification and the selector 106 selects the processing data, the executor 107 executes the specific processing on the selected processing data. The executor 107 transmits information, such as a result of the processing, to the server 200 when necessary. For example, in a case of executing the vehicle identification processing as the specific processing and determining that the vehicle whose license number is recognized is not a permitted vehicle, the executor 107 notifies the server 200 of the detection of a vehicle having no permission to pass.

The transmitter 108 transmits the processing data (or partial data) to the IoT device 100 determined as the destination device by the determiner 103. For example, the transmitter 108 stores the data input from the detector 102 as data to be transmitted to another IoT device 100, in the storage 121 or the like. When the server 200 determines the destination device, the transmitter 108 transmits the stored data to the destination device.

Note that the IoT device 100 may be configured to execute another processing (additional processing) on the processing data in accordance with result data indicating the processing result from the executor 107 or a result of the processing on the processing data at the destination device.

In this case, for example, the detector 102 further detects whether the classification of the result data is an additional processing classification indicating a classification being a target of the additional processing. If it is detected that the classification of the result data is the additional processing classification, the determiner 103 further determines another IoT device 100 for processing the result data as a destination device. For example, the determiner 103 queries the server 200 for an IoT device 100 associated with a specific classification using the classification notifier 104, thereby determining the destination device.

For example, it is assumed that the IoT device 100b performs person authentication processing as the specific processing and the IoT device 100c performs action presumption processing as the specific processing. It is also assumed that the executor 107 of the IoT device 100b executes the person authentication processing and it is then detected that a person is unregistered (for example, a suspicious person). Then, the executor 107 passes the result data to the detector 102. The detector 102 detects that the result data indicates, for example, a suspicious person classification defined as an additional processing classification. The determiner 103 queries the server 200 for an IoT device 100 associated with the suspicious person classification using the classification notifier 104, thereby determining a destination device. The server 200 determines an IoT device 100 for executing the action presumption processing on the data indicating the suspicious person classification as the destination device, for example.

Assuming that the IoT device 100c is determined as the destination device for executing the action presumption processing, the transmitter 108 of the IoT device 100b transmits the processing data to the IoT device 100c. With this function, the information processing system 10 can be configured to presume the probability of dangerous action of a suspicious person.

The above-described constituents (acceptor 101, detector 102, determiner 103, classification notifier 104, receiver 105, selector 106, executor 107, and transmitter 108) are each implemented by, for example, one or more hardware processors. For example, the above-described constituents may be implemented by causing a processor, such as a CPU, to execute a computer program, that is, implemented by software. The above-described constituents may be implemented by a processor of a dedicated integrated circuit (IC) or the like, that is, implemented by hardware. The above-described constituents may be implemented by a combination of software and hardware. If two or more processors are used, each processor may implement one of the constituents or two or more of the constituents.

The storage 121 stores various types of data used for various types of processing at the IoT device 100. For example, the storage 121 stores the processing data accepted by the acceptor 101 and the data (processing data, partial data) to be transmitted to the destination device.

The storage 121 can be configured with any commonly used storage medium, such as flash memory, a memory card, random access memory (RAM), a hard disk drive (HDD), and an optical disk.

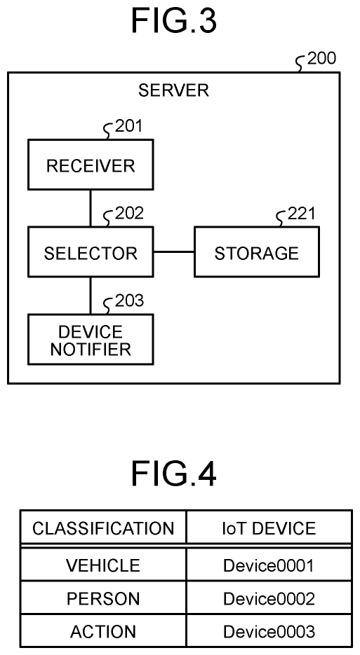

FIG. 3 is a block diagram illustrating an example configuration of the server 200. As illustrated in FIG. 3, the server 200 includes a receiver 201, a selector 202, a device notifier 203, and a storage 221.

The storage 221 stores various types of data used for various types of processing at the server 200. For example, the storage 221 stores the notification information received from the IoT device 100 and association information for determining a destination device. The storage 221 can be configured with any commonly used storage medium, such as flash memory, a memory card, RAM, a HDD, and an optical disk.

FIG. 4 is a diagram illustrating an example data structure of the association information. As illustrated in FIG. 4, the association information is formed into a list in which data classifications are associated with the identification information of the IoT devices 100 that can process data of the respective classifications. A plurality of pieces of the identification information may be associated with a single classification. While FIG. 4 illustrates example association information, another information may further be included and the data structure may have a form other than a list form.

The receiver 201 receives data from an external device such as the IoT device 100. For example, the receiver 201 receives the notification information from the IoT device 100. The receiver 201 passes the received notification information to the selector 202.

The selector 202 selects an IoT device 100 associated with the classification included in the notification information input from the receiver 201, as a destination device. For example, the selector 202 refers to the association information to select one of the IoT devices 100 associated with the classification included in the notification information, as the destination device. The selector 202 transmits the identification information of the selected IoT device 100 (destination identification information) in addition to the identification information of the source IoT device 100 (source identification information) and transmits the identification information to the device notifier 203.

In a case where two or more pieces of the identification information are associated with a single classification in the association information, the selector 202 may select one of the IoT devices 100 (one of the pieces of the identification information) in consideration of at least one of a processing load, an operation state, and network latency (network delay) of each IoT device 100.

The device notifier 203 notifies the IoT device 100, which is the source of the notification information, of device information indicating the selected IoT device 100. For example, the device notifier 203 transmits the device information indicating the destination identification information to the IoT device 100 corresponding to the source identification information transmitted from the selector 202.

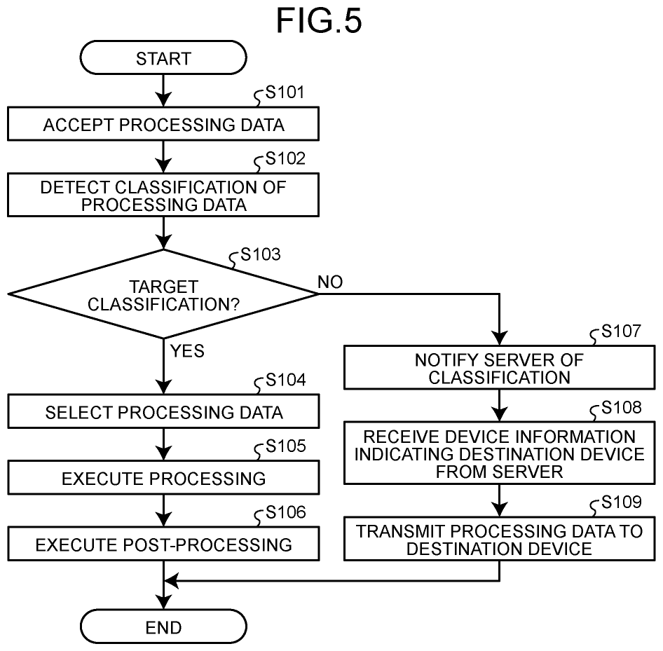

Next, information processing at the IoT device 100 according to the first embodiment will be described. FIG. 5 is a flowchart illustrating example information processing according to the first embodiment. The acceptor 101 accepts the input of processing data from the sensor 150 (step S101). The detector 102 detects a classification of the processing data (step S102). The detector 102 determines whether the classification is a target classification being a target for the IoT device 100 (step S103).

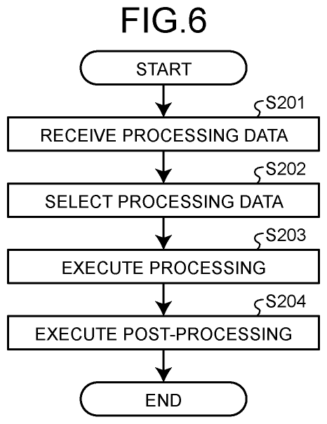

When the classification of the processing data is determined to be the target classification (Yes at step S103), the detector 102 passes the processing data to the selector 106. In this example, it is assumed here that the selector 106 selects the input processing data (step S104). Note that processing when the selector 106 selects processing data received from another IoT device 100, in other words, when the IoT device 100 operates as a destination device will be described later with reference to FIG. 6.

The executor 107 executes processing on the selected processing data (step S105). The executor 107 executes post-processing when necessary (step S106). For example, the executor 107 performs post-processing, such as notification of a processing result to the server 200.

When the classification of the processing data is determined at step S103 not to be the target classification (No at step S103), the determiner 103 executes processing for determining a destination device. For example, the determiner 103 notifies the server 200 of notification information including the non-target classification using the classification notifier 104 (step S107). The classification notifier 104 (or receiver 105) receives device information transmitted from the server 200 in response to the notification information (step S108). The transmitter 108 transmits the processing data to the IoT device 100 corresponding to the destination device indicated by the received device information (step S109).

FIG. 6 is a flowchart illustrating example information processing at the IoT device 100 operating as a destination device.

The receiver 105 of the IoT device 100 as a destination device receives data (transfer data) transmitted from another IoT device 100 (step S201). It is assumed here that the selector 106 selects the received data (step S202). The executor 107 executes processing on the selected processing data (transfer data) (step S203). The executor 107 executes post-processing when necessary (step S204).

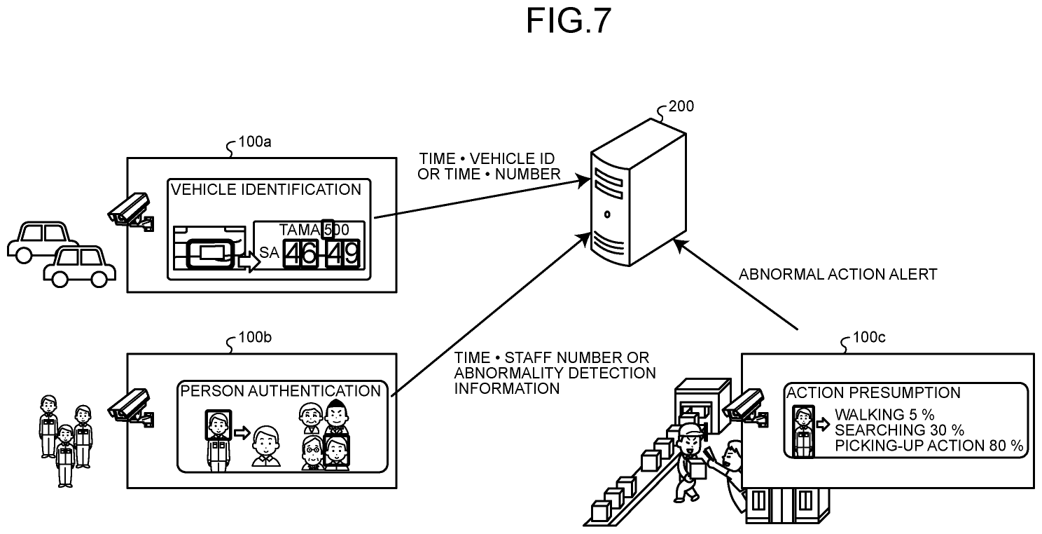

Next, a specific example of the information processing system 10 of this embodiment will be described. FIG. 7 is a diagram illustrating an example configuration of the information processing system 10. As illustrated in FIG. 7, three IoT devices 100a, 100b, and 100c are each configured to execute the following specific processing.
IoT device 100a: Vehicle identification processing
IoT device 100b: Person authentication processing
IoT device 100c: Action presumption processing

The IoT device 100a is, for example, a camera-equipped device that specializes in vehicle identification and is intended to be installed at a vehicle gate of a facility or the like. The IoT device 100a recognizes the license number of a vehicle passing the vehicle gate, checks the license number against a registered license number, and, in the case of a registered vehicle, notifies the server 200 of information for identifying the vehicle (vehicle ID, license number, or the like) and passing time. When an unregistered vehicle is recognized, the IoT device 100a notifies the server 200 of image data and information for identifying the vehicle.

The IoT device 100b is, for example, a camera-equipped device that specializes in person authentication and is intended to be installed at a gate where people pass, such as a staff gate. The IoT device 100b executes processing of face detection and face recognition of a person passing the staff gate and authenticates a person registered as staff. In the case of a registered person, the IoT device 100b notifies the server 200 of information for identifying the person (staff number or the like) and passing time. When an unregistered person is detected, the IoT device 100b closes the gate and notifies the server 200 of the detection result.

The IoT device 100c is, for example, a device that is equipped with a camera (surveillance camera) and intended to give a warning to a suspicious behavior or action in a storehouse or the like. The IoT device 100c is configured to presume the type of action to be taken by a person captured by the camera. For example, the IoT device 100c is configured to execute advanced AI processing for presuming the probability of various actions, such as normal walking, passing while looking around, and a behavior appearing to be searching for something.

Each of the IoT devices 100a, 100b, and 100c has an efficient configuration specializing in specific processing assigned to the device. For example, the executor 107 of the IoT device 100a is configured to have minimum computing performance for the execution of the vehicle identification processing. Alternatively, the executor 107 is configured with a hardware circuit specializing in the vehicle identification processing, and cannot execute processing other than the vehicle identification processing but can execute the vehicle identification processing with low power consumption or at high speed. That is, each IoT device 100 is configured to be more efficient in processing performance, power consumption, and the like. Note that each piece of the specific processing may be implemented by any method, and, for example, a method using a machine learning model, such as a neural network, may be applied.

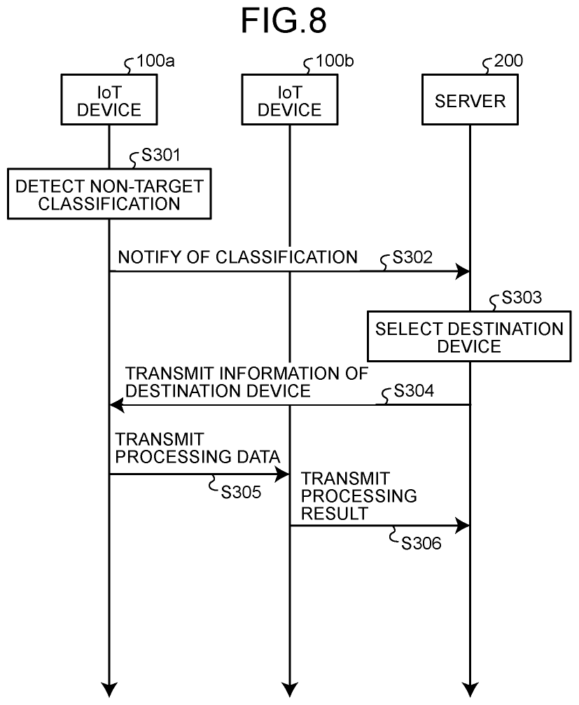

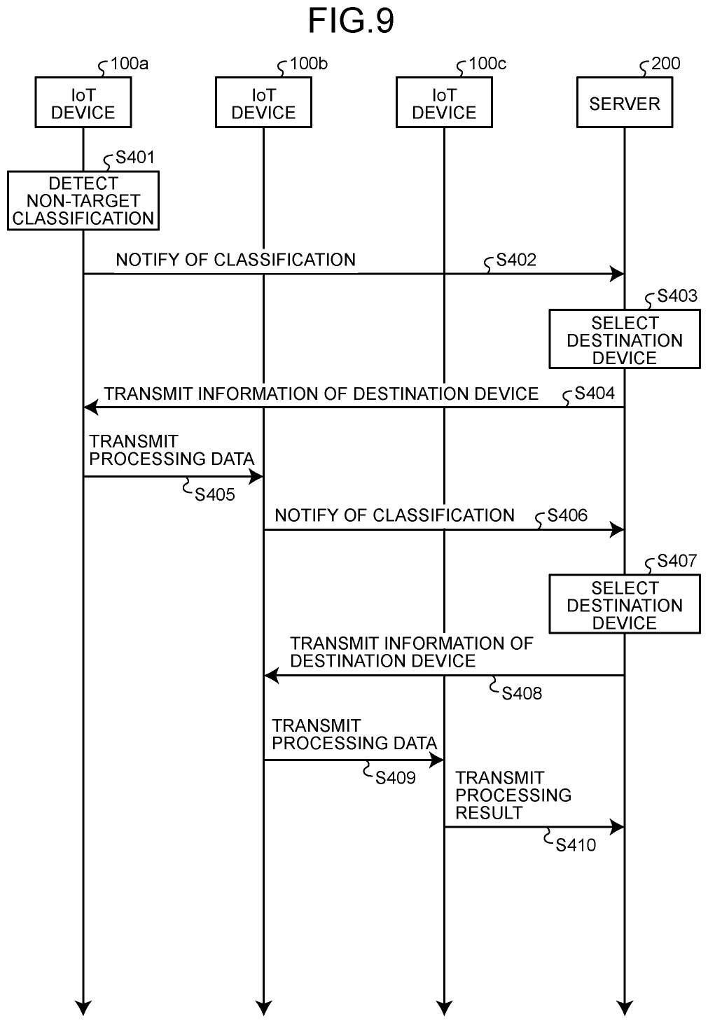

According to the present embodiment, in an environment using the IoT devices 100 as illustrated in FIG. 7, distributed processing can be more efficiently executed by the IoT devices 100. Specific examples of the distributed processing will be described with reference to FIGS. 8 and 9.

FIG. 8 is a diagram illustrating example distributed processing using the IoT device 100a and the IoT device 100b. FIG. 8 exemplifies a case where the IoT device 100a is installed in a vehicle gate and a person who does not normally pass the vehicle gate is detected at this vehicle gate.

The detector 102 of the IoT device 100a detects that processing data is of a non-target classification (person) (step S301). The classification notifier 104 of the IoT device 100a notifies the server 200 of the detection of the processing data whose classification is person (step S302).

The selector 202 of the server 200 selects, with reference to the association information, the IoT device 100b as a device (destination device) for executing the person authentication processing for the classification “person” (step S303). The device notifier 203 of the server 200 returns device information including identification information of the selected IoT device 100b to the IoT device 100a (step S304).

The transmitter 108 of the IoT device 100a transmits the processing data (such as a video stream) of the detected person to the IoT device 100b identified by the identification information included in the device information (step S305).

The IoT device 100b executes the person authentication processing on the received processing data (transfer data) and transmits a result of the processing to the server 200 (step S306). For example, if the person authentication processing authenticates a person registered as staff, the IoT device 100b notifies the server 200 of passing time together with the identification information of the IoT device 100a. This enables such record that an authenticated person has passed, for some reason, the vehicle gate where the IoT device 100a is installed and people do not normally pass. This enables a manager to take action in accordance with a facility management policy, for example, to ask the person about the reason for the passing.

If the person authentication processing determines that the person is unregistered (a person who is not registered as staff or the like), the IoT device 100b notifies the server 200 of the authentication result together with the identification information of the IoT device 100a. In this case, the manager can also take action in accordance with the facility management policy in response to the notification.

FIG. 9 is a diagram illustrating example distributed processing using the IoT device 100a, the IoT device 100b, and the IoT device 100c. FIG. 9 exemplifies a case of detection of an unregistered person as a result of the person authentication processing similar to the case of FIG. 8. In this example, the IoT device 100c is configured to presume the probability of dangerous action of the unregistered person.

Steps S401 to S405 are similar to steps S301 to S305 in FIG. 8.

If an unregistered person is detected, the classification notifier 104 of the IoT device 100b notifies the server 200 of the detection of processing data corresponding to the suspicious person classification (step S406).

The selector 202 of the server 200 having received notification information indicating the suspicious person classification from the IoT device 100b refers to the association information to select the IoT device 100c as a device (destination device) for executing the action presumption processing on the processing data of the suspicious person classification (step S407). The device notifier 203 of the server 200 returns device information including identification information of the selected IoT device 100c to the IoT device 100b (step S408).

The transmitter 108 of the IoT device 100b transmits the processing data (such as a video stream) determined as the suspicious person classification and the identification information of the IoT device 100a being the device having acquired the processing data, to the IoT device 100c identified by the identification information included in the device information (step S409).

The IoT device 100c executes the action presumption processing on the received processing data (transfer data) and transmits a result of the processing to the server 200 (step S410). For example, the IoT device 100c notifies the server 200 of the probability of dangerous action being a detection result together with information indicating the suspicious person classification. This enables the manager to take action in accordance with the facility management policy, for example, to have a security guard rush to the site.

### First Modification

As described above, the sensor 150 may be a sensor other than a camera. In other words, the information processing system 10 is not limited to a system distributing processing on image data. For example, each IoT device 100 may include some or all of a temperature sensor, a humidity sensor, a vibration sensor, and an acoustic sensor.

For example, an IoT device 100a includes at least a temperature sensor and a vibration sensor and is assigned abnormality sensing processing as specific processing, which uses sensing data (example processing data) from the temperature sensor. An IoT device 100b includes at least a vibration sensor and an acoustic sensor and is assigned abnormality sensing processing as specific processing, which uses sensing data from the vibration sensor and sensing data (acoustic data) from the acoustic sensor.

For example, in a case where abnormal vibration is detected from sensing data from the vibration sensor, the IoT device 100a queries the server 200 for another IoT device 100 configured to execute the abnormality sensing processing as specific processing in order to execute further detailed abnormality sensing processing or the like on this sensing data. When the server 200 selects the IoT device 100b, the IoT device 100a is able to transmit the sensing data to the selected IoT device 100b to cause the IoT device 100b to execute the abnormality sensing processing.

Note that, in a case where the two or more sensors 150 are provided as in the first modification, the acceptor 101 accepts input of processing data from each of the sensors 150. The detector 102 may detect whether the classification of each of plural pieces of the processing data accepted from the respective sensors 150 is a target classification or a non-target classification. The transmitter 108 may transmit only one (for example, the processing data used for the specific processing at the destination device) of the plural pieces of the processing data input from the sensors 150, to the destination device.

### Second Modification

In the above-described embodiment, the processing data itself is not transmitted to the server 200, and only the notification information including information indicating a classification (non-target classification) is transmitted to the server 200. Thus, for example, even if the system is configured so that each IoT device 100 is provided in a private network (for example, a LAN) and the server 200 is provided in a network (for example, a public network, such as the Internet) outside the private network, such a configuration is possible as not to transmit data itself that should be kept confidential against the outside network. That is, requirements from the viewpoints of security and privacy protection, such as not wanting data acquired by the sensor 150 to be leaked out to the outside network, can be satisfied.

Note that the server 200 may be implemented as a server (such as a gateway server and a local server) provided in the same network as that provided with the IoT devices 100 instead of an outside network.

Moreover, the IoT device 100 may transmit, to the server 200, the processing data acquired by the sensor 150 or a portion of the processing data (partial data) as additional information for selecting a destination device at the server 200, and the server 200 may utilize the data to determine a destination device.

It is assumed that, for example, the detector 102 of the IoT device 100 can detect whether the classification of the processing data is a target classification (for example, a vehicle) or otherwise (for example, not a vehicle) but cannot detect details of a non-target classification (for example, whether it is a person or a transfer robot). In this case, the classification notifier 104 notifies the server 200 of the processing data together with information indicating that the data is of a non-target classification. The server 200 detects a detailed classification of the processing data using the processing data and selects a destination device associated with the detected classification.

In this example, not only the notification information but also the processing data are transmitted to the server 200; however, for example, with a configuration having the server 200 being a local server as described above, requirements of security and privacy protection can be satisfied.

### Third Modification

In the above-described embodiment, the destination IoT device 100 transmits, to the server 200, a processing result of specific processing executed by itself. The processing result may be transmitted to the source IoT device 100, and the source IoT device 100 may execute necessary post-processing, such as the notification of the processing result to the server 200.

As described above, in the first embodiment, when non-target processing other than specific processing executed by an IoT device is necessary, another IoT device specializing in the non-target processing is determined, data is transmitted to that IoT device, and the IoT device can perform the non-target processing as a substitute. This enables more efficient execution of distributed processing by a plurality of devices.

For example, without increases in the power consumption and device size of each IoT device, more advanced processing can be executed in a distributed manner. Such a configuration can be made as not to transmit processing data to the server, thus enabling a reduction in power consumption, a reduction in the amount of network traffic, a simplified server configuration, and the like. Moreover, by eliminating the need to transmit data having a low level of abstraction to the server, security risk and privacy risk can be reduced.

### Second Embodiment

In the foregoing first embodiment, the server selects another IoT device (destination device) for executing non-target processing. In an information processing system according to a second embodiment, a source IoT device has a function to select a destination device. An example described below includes a server, whereas the information processing system of this embodiment may include no server.

The information processing system of this embodiment has the same overall configuration as that in FIG. 1 illustrating a configuration of the information processing system 10 of the first embodiment, and thus the description is omitted. Note that not all the IoT devices in the information processing system 10 necessarily have functions of the second embodiment described below, and, for example, one of the IoT devices may have a function of the first embodiment.

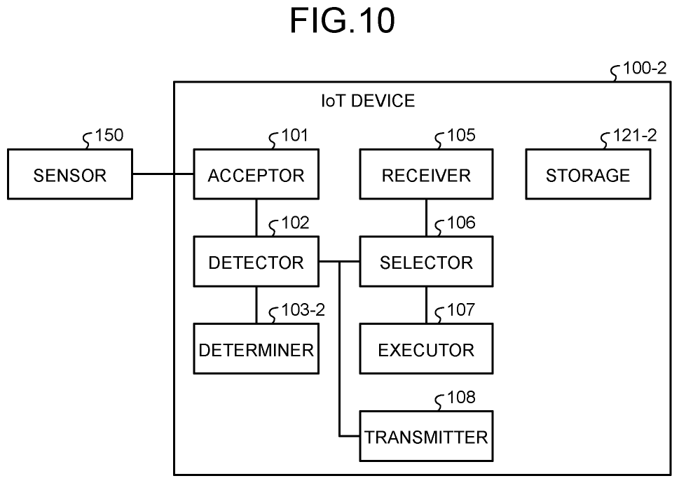

FIG. 10 is a block diagram illustrating an example configuration of an IoT device 100-2 according to the second embodiment. As illustrated in FIG. 10, the IoT device 100-2 includes an acceptor 101, a detector 102, a determiner 103-2, a receiver 105, a selector 106, an executor 107, a transmitter 108, and a storage 121-2.

The second embodiment is different from the first embodiment in removal of the classification notifier 104 and the functions of the storage 121-2 and the determiner 103-2. The other configurations and functions are the same as those in FIG. 2 being a block diagram of the IoT device 100 according to the first embodiment, and thus the same reference signs are used and the description is omitted below.

The storage 121-2 is different from the storage 121 of the first embodiment in that association information for determining a destination device is further stored. The data structure of the association information is the same as that of the first embodiment (FIG. 4).

The determiner 103-2 refers to the association information stored in the storage 121-2 to determine another IoT device 100-2 associated with a classification included in the association information, as a destination device. In a case where two or more pieces of the identification information are associated with a single classification in the association information, similar to the selector 202 of the server 200 of the first embodiment, the determiner 103-2 may determine one of the IoT devices 100-2 (identification information) as a destination device in consideration of at least one of a processing load, an operation state, and network latency of another IoT device 100-2.

Note that, if the function of the server 200 to select a destination device is also usable, similar to the first embodiment, the classification notifier 104 may be provided. For example, if a destination device is not determined from the association information stored in the storage 121-2, the determiner 103-2 may query the server 200 for a destination device using the classification notifier 104.

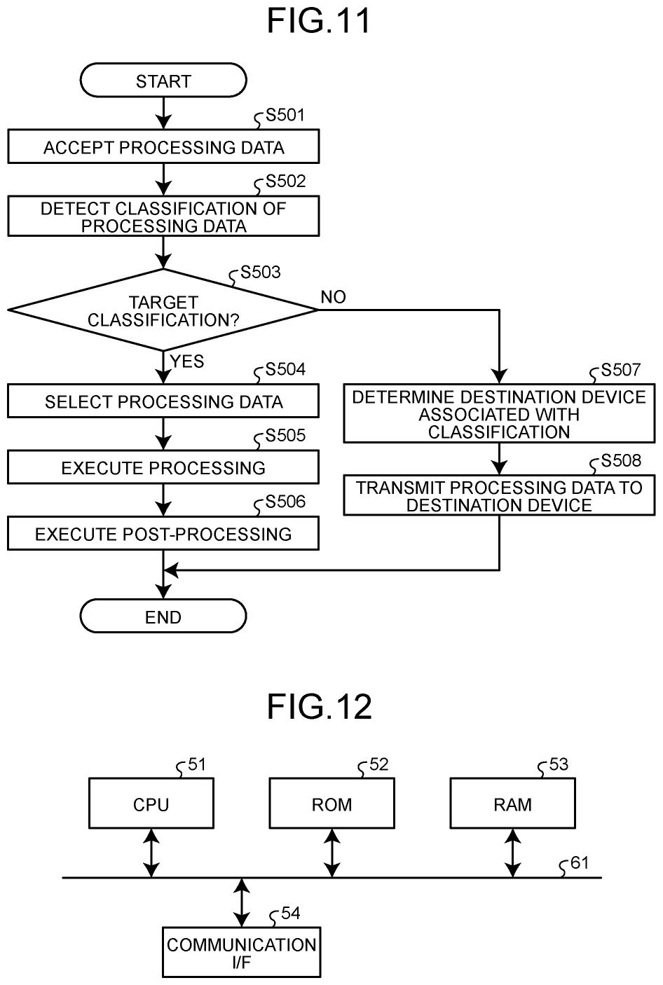

Next, information processing at the IoT device 100-2 according to the second embodiment will be described. FIG. 11 is a flowchart illustrating example information processing according to the second embodiment.

Steps S501 to S506 are processing similar to steps S101 to S106 at the IoT device 100 according to the first embodiment, and thus the description is omitted.

In this embodiment, when the classification of the processing data is determined not to be a target classification (No at step S503), the determiner 103-2 specifies the IoT device 100-2 associated with the classification (non-target classification) of the processing data from the association information stored in the storage 121-2 and determines the specified IoT device 100-2 as a destination device (step S507). The transmitter 108 transmits the processing data to the IoT device 100-2 corresponding to the determined destination device (step S508).

In this manner, the information processing system according to the second embodiment can determine a destination device with no query to the server.

As described above, in accordance with the first to second embodiments, distributed processing can be executed more efficiently by plural devices.

Next, hardware configuration of devices (IoT device and server) according to the first or second embodiment will be described with reference to FIG. 12. FIG. 12 is an explanatory diagram illustrating an example hardware configuration of the device according to the first or second embodiment.

The device according to the first or second embodiment includes a control device, such as a CPU 51, a storage device, such as read only memory (ROM) 52 and RAM 53, a communication I/F 54 connected to a network to perform communications, and a bus 61 connecting the constituents to each other.

A computer program executed by the device according to the first or second embodiment is provided, preliminarily installed in the ROM 52 or the like.

The computer program executed by the device according to the first or second embodiment may be configured to be provided as a computer program product recorded as an installable or executable file in a computer-readable recording medium, such as compact disc read only memory (CD-ROM), a flexible disk (FD), a compact disc recordable (CD-R), and a digital versatile disc (DVD).

Alternatively, the computer program executed by the device according to the first or second embodiment may be configured to be stored in a computer connected to a network, such as the Internet, and to be provided through downloading via the network. Alternatively, the computer program executed by the device according to the first or second embodiment may be configured to be provided or distributed via a network, such as the Internet.

The computer program executed by the device according to the first or second embodiment allows a computer to function as each of the above-described constituents of the device. In this computer, the CPU 51 can load the computer program from a computer-readable storage medium onto a main storage device and can execute the computer program.

While certain embodiments have been described, these embodiments have been presented by way of example only, and are not intended to limit the scope of the inventions. Indeed, the novel embodiments described herein may be embodied in a variety of other forms; moreover, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing system comprising:
a plurality of information processing devices, each device including one or more first hardware processors configured to:
accept input of processing data;
detect whether a classification of the processing data is a target classification or a non-target classification, the target classification being a target of predetermined first processing, the non-target classification not being a target of the first processing;
execute the first processing on the processing data upon detection of the classification of the processing data being the target classification;
determine, as a destination device, a device in the plurality of information processing devices that serves to perform processing on data of the non-target classification, the determination being made upon detection of the classification of the processing data being the non-target classification; and
transmit at least some pieces of the processing data to the determined destination device.

2. The information processing system according to claim 1, wherein at least some devices of the plurality of information processing devices are assigned mutually different pieces of processing as the first processing.

3. The information processing system according to claim 1, further comprising a server device, wherein
the one or more first hardware processors are configured to
upon detection of the classification of the processing data being the non-target classification, notify the server device of notification information including the non-target classification, and
determine the destination device on the basis of device information indicating a device in the plurality of information processing devices that serves to perform processing on data of the non-target classification, the device information being transmitted from the server device in response to the notification information.

4. The information processing system according to claim 3, wherein the server device includes one or more second hardware processors configured to:
receive the notification information from the information processing device;
select an information processing device serving to perform processing on data of the non-target classification from among the plurality of information processing devices, on the basis of the non-target classification included in the notification information; and
notify the information processing device transmitting the notification information of the device information indicating the selected information processing device.

5. The information processing system according to claim 4, wherein the one or more second hardware processors select the information processing device serving to perform processing on data of the non-target classification from among the plurality of information processing devices, on the basis of at least one of processing load, an operation state, and a network delay of the plurality of information processing devices.

6. The information processing system according to claim 1, wherein
each device in the plurality of information processing devices further includes a memory configured to store association information in which the non-target classification is associated with the information processing device serving to perform processing on data of the non-target classification, and
the one or more first hardware processors determine, as the destination device, the information processing device associated with the non-target classification included in the association information.

7. The information processing system according to claim 1, wherein
the one or more first hardware processors further detect whether a classification of result data is a predetermined additional processing classification, the result data being a processing result of the first processing by the executer or a processing result of processing executed on the processing data by the destination device, and,
upon detection of the classification of the result data being the additional processing classification, the one or more first hardware processors further determine, as a destination device, a device in the plurality of information processing devices that serves to perform processing on the result data.

8. The information processing system according to claim 1, wherein the one or more first hardware processors
execute, on the processing data, recognition processing of recognizing a classification of data, and
detect whether a classification of the processing data is the target classification or the non-target classification, on the basis of a result of the recognition processing.

9. The information processing system according to claim 1, wherein
the one or more first hardware processors
accept input of the processing data from each of input devices, and
detect whether a classification of each piece of the processing data accepted from each of the input devices is the target classification or the non-target classification.

10. The information processing system according to claim 1, wherein the one or more first hardware processors transmit, to the destination device, partial data included in a single piece of the processing data or some pieces of the input processing data.

11. An information processing method executed by an information processing system including a plurality of information processing devices, the method comprising:
accepting input of processing data;
detecting whether a classification of the processing data is a target classification or a non-target classification, the target classification being a target of predetermined first processing, the non-target classification not being a target of the first processing;
executing the first processing on the processing data upon detection of the classification of the processing data being the target classification;
determining, as a destination device, a device in the plurality of information processing devices that serves to perform processing on data of the non-target classification, the determining being performed upon detection of the classification of the processing data being the non-target classification; and
transmitting at least some pieces of the processing data to the destination device.

12. An information processing device comprising:
one or more hardware processors configured to:
accept input of processing data;
detect whether a classification of the processing data is a target classification or a non-target classification, the target classification being a target of predetermined first processing, the non-target classification not being a target of the first processing;
execute the first processing on the processing data upon detection of the classification of the processing data being the target classification;
determine, as a destination device, an information processing device serving to perform processing on data of the non-target classification, the determination being made upon detection of the classification of the processing data being the non-target classification; and
transmit at least some pieces of the processing data to the destination device determined by the determiner.

13. A computer program product comprising a non-transitory computer-readable recording medium on which a program executable by a computer of an information processing device is recorded, the program instructing the computer to:
accept input of processing data;
detect whether a classification of the processing data is a target classification or a non-target classification, the target classification being a target of predetermined first processing, the non-target classification not being a target of the first processing;
execute the first processing on the processing data upon detection of the classification of the processing data being the target classification;
determine, as a destination device, an information processing device serving to perform processing on data of the non-target classification, the determination being made upon detection of the classification of the processing data being the non-target classification; and
transmit at least some pieces of the processing data to the destination device.
